(19) United States
(12) Patent Application Publication
(10) Pub. No.: US 2015/0067546 A1
(43) Pub. Date: Mar. 5, 2015

(54) ELECTRONIC APPARATUS, METHOD AND STORAGE MEDIUM

(71) Applicant: KABUSHIKI KAISHA TOSHIBA, Tokyo (JP)

(72) Inventor: Eita Shuto, Tokyo (JP)

(73) Assignee: KABUSHIKI KAISHA TOSHIBA, Tokyo (JP)

(21) Appl. No.: 14/192,473

(22) Filed: Feb. 27, 2014

(30) Foreign Application Priority Data
Aug. 30, 2013 (JP) 2013-179524

(51) Int. Cl. G06F 3/0484; G06F 3/0488; G06F 17/22

(52) U.S. Cl. CPC G06F 3/0484; G06F 17/2247; G06F 3/04883; G06F 3/04842; G06F 3/04845
USPC 715/760; 715/863

(57) ABSTRACT

According to one embodiment, an electronic apparatus includes a processor. The processor is configured to designate, in accordance with a first operation for specifying a first region on first information displayed on a screen, the first region as a first selection region. The processor is configured to designate, in accordance with a second operation for specifying a second region in the first region, a region in the first region except the second region as a second selection region.

### CROSS-REFERENCE TO RELATED APPLICATIONS

This application is based upon and claims the benefit of priority from Japanese Patent Application No. 2013-179524, filed Aug. 30, 2013, the entire contents of which are incorporated herein by reference.

### FIELD

Embodiments described herein relate generally to information processing technology suitable for an electronic apparatus and the like including a function of viewing, for example, a Web page released on the Internet.

### BACKGROUND

In recent years, various electronic apparatuses such as personal computers, tablets and smartphones have spread. These kinds of electronic apparatus are provided with a pointing device for designating an arbitrary position or a region on a screen. The pointing device is, for example, a mouse or a touch pad in a personal computer, or a touchpanel or a digitizer in a tablet and a smartphone.

By designating the arbitrary region on the screen by an operation of the pointing device, a user can, for example, cut out and save only a necessary portion on a Web page which the user is viewing. The portion cut out and saved from the Web page is called a clip or a scrap.

Designation of the arbitrary region on the screen, for example, designation of the portion which the user wants to cut out and save from the Web page as a clip or a scrap, can be easily carried out by the operation of the pointing device as described above.

However, since the pointing device basically has no modes, it is difficult, for example, to give instructions to exclude a part of a designated region after designation of the arbitrary region on the screen, more specifically, to designate the region which the user wants to delete by the same operation of the pointing device as that at designation of the arbitrary region on the screen.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an outer appearance of an electronic apparatus according to an embodiment.

FIG. 2 is an exemplary block diagram showing a system configuration of the electronic apparatus according to the embodiment.

FIG. 3 is an exemplary illustration showing an example of screen transition at the time of extracting a clip from a document (Web page) of the electronic apparatus according to the embodiment.

FIG. 4 is an exemplary illustration for explanation of a structure of an HTML file.

FIG. 5 is an exemplary illustration showing an example of displaying the Web page based on the HTML file shown in FIG. 4.

FIG. 6 is an exemplary illustration for explanation of a first pattern of a region deleting operation by a pointing device in the electronic apparatus according to the embodiment.

FIG. 7 is an illustration for explanation of a method for excluding an element when designating a deletion region in the electronic apparatus according to the embodiment.

FIG. 8 is an exemplary functional block diagram of a clipping module incorporated in a browser application program operating in the electronic apparatus according to the embodiment.

FIG. 9 is an exemplary illustration for explanation of a second pattern of the region deleting operation by the pointing device in the electronic apparatus according to the embodiment.

FIG. 10 is an exemplary illustration for explanation of a third pattern of the region deleting operation by the pointing device in the electronic apparatus according to the embodiment.

FIG. 11 is an exemplary first illustration for explanation of a technique for determining an entry direction of a closed curve in the electronic apparatus according to the embodiment.

FIG. 12 is an exemplary second illustration for explanation of the technique for determining the entry direction of the closed curve in the electronic apparatus according to the embodiment.

FIG. 13 is an exemplary flowchart showing a flow of region selection (first pattern) by the pointing device in the electronic apparatus according to the embodiment.

FIG. 14 is an exemplary flowchart showing a flow of region selection (second pattern) by the pointing device in the electronic apparatus according to the embodiment.

FIG. 15 is an exemplary flowchart showing a flow of region selection (third pattern) by the pointing device in the electronic apparatus according to the embodiment.

### DETAILED DESCRIPTION

Various embodiments will be described hereinafter with reference to the accompanying drawings.

In general, according to one embodiment, an electronic apparatus includes a processor. The processor is configured to designate, in accordance with a first operation for specifying a first region on first information displayed on a screen, the first region as a first selection region. The processor is configured to designate, in accordance with a second operation for specifying a second region in the first region, a region in the first region except the second region as a second selection region.

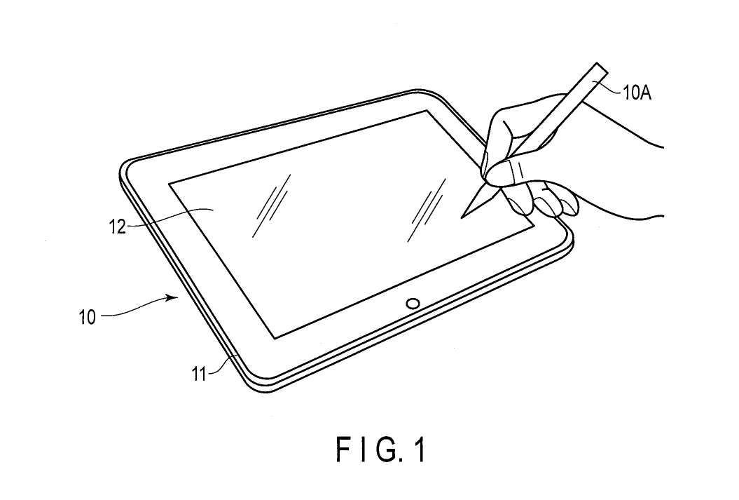

FIG. 1 is an exemplary perspective view showing an outer appearance of an electronic apparatus according to one of the embodiments. The electronic apparatus is, for example, a portable electronic apparatus in which handwriting input can be performed by a pen or a finger. The electronic apparatus can be implemented as a tablet computer, a notebook-type personal computer, a smartphone, a PDA, and the like. In the following description, it is assumed that the electronic apparatus is implemented as a tablet computer 10. The tablet computer 10 is a portable electronic apparatus called a tablet or slate computer. The tablet computer 10 can function as a terminal for Web browsing, transmission and reception of emails, use of a social networking service (SNS), and the like. The tablet computer 10 includes a main body 11 and a touchscreen display 12 as shown in FIG. 1. The touchscreen display 12 is mounted to be overlaid on a top surface of the main body 11.

The main body 11 has a housing shaped like a thin box. A flat panel display and a sensor configured to detect a touch position of a pen or a finger on a screen of the flat panel display are incorporated in the touchscreen display 12. The flat panel display may be, for example, a liquid crystal display (LCD). For example, a capacitive touchpanel, an electromagnetic induction type digitizer, etc., can be used as the sensor. In the following descriptions, it is assumed that both types of sensor, i.e., a digitizer and a touchpanel, are incorporated in the touchscreen display 12.

The digitizer and the touchpanel are each provided to overlap the screen of the flat panel display. The touchscreen display 12 can detect not only a touch operation on the screen using the finger but a touch operation on the screen using a pen 10A. The pen 10A may be, for example, an electromagnetic induction type pen. A user can perform various gesture operations such as tap, drag, swipe and flick on the touchscreen display 12 by using the pen 10A or the finger.

The user also can perform a handwriting input operation on the touchscreen display 12 by using the pen 10A. In the handwriting input operation, a path of a motion of the pen 10A on the screen, i.e., a stroke handwritten by the handwriting input operation (path of a handwritten stroke), is drawn in real time and thus a plurality of strokes input in handwriting (path of each handwritten stroke) are displayed on the screen.

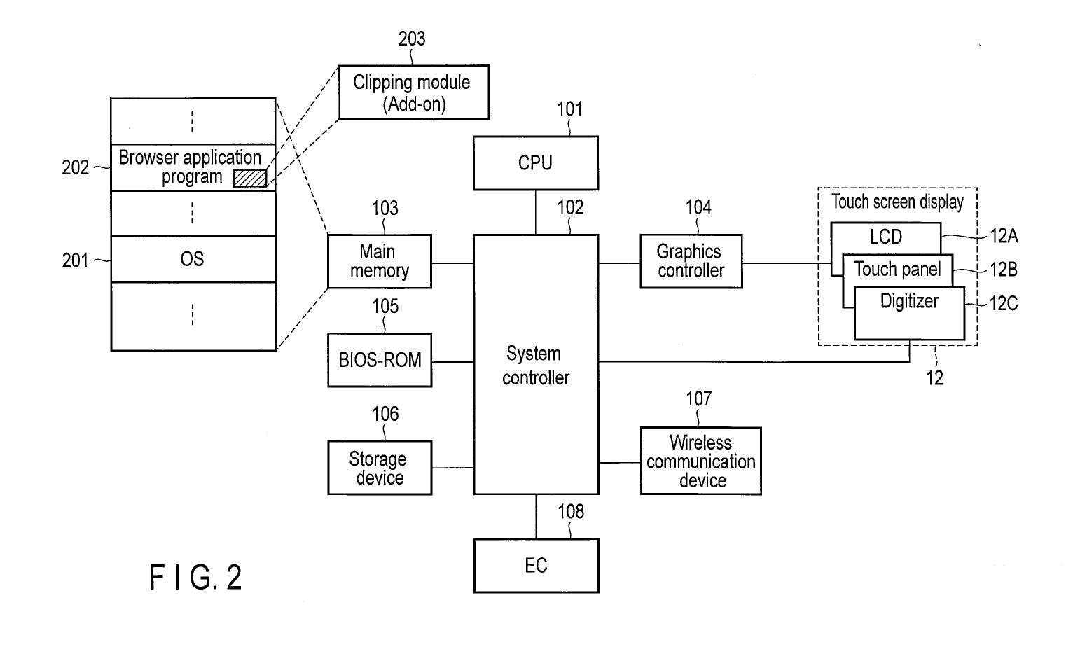

FIG. 2 is an exemplary block diagram showing a system configuration of the tablet computer 10 according to the embodiment.

As shown in FIG. 2, the tablet computer 10 includes a CPU 101, a system controller 102, a main memory 103, a graphics controller 104, a BIOS-ROM 105, a storage device 106, a wireless communication device 107, an embedded controller (EC) 108, and the like.

The CPU 101 is a processor configured to control operations of various modules in the tablet computer 10. The CPU 101 is configured to load various programs from the storage device 106 into the main memory 103 and to execute the programs. The programs executed by the CPU 101 include an operating system (OS) 201 and various application programs such as a browser application program 202, which operates under the control of the OS 201. The browser application program 202 includes a function of acquiring data of a Web page from a Web server and displaying the Web page on the screen. The browser application program 202 also achieves a clipping function by incorporating therein a clipping module 203, which is add-on software. A module for achieving the clipping function (module corresponding to the clipping module 203) may be incorporated in the browser application program 202 in advance.

The clipping function is a function of saving a clip (clip data) including at least a part of a displayed document on a storage medium. In other words, the clip is created from the document or a part of the document. Although kinds of document to which the clipping function can be applied are not limited, examples of the document include, for example, a Web page.

Moreover, the CPU 101 is also configured to execute a basic input/output system (BIOS) stored in the BIOS-ROM 105. The BIOS is a program for hardware control.

The system controller 102 is a device configured to connect a local bus of the CPU 101 with various components. A memory controller configured to perform access control over the main memory 103 is also built in the system controller 102. The system controller 102 includes also a function of communicating with the graphics controller 104 via a serial bus, etc.

The graphics controller 104 is a display controller configured to control an LCD 12A used as a display monitor of the tablet computer 10. A display signal generated by the graphics controller 104 is transmitted to the LCD 12A. The LCD 12A is configured to display a picture image based on the display signal. On an upper layer of the LCD 12A, a touchpanel 12B is arranged as a first sensor for detecting a touch position of the finger on the screen. Moreover, on a lower layer of the LCD 12A, a digitizer 12C is arranged as a second sensor for detecting a touch position of the pen 10A on the screen. The touchpanel 12B is a capacitive pointing device for input on the screen of the LCD 12A. A touch position on the screen which the finger touches, a motion of the touch position, etc., are detected by the touchpanel 12B. The digitizer 12C is an electromagnetic induction type pointing device for input on the screen of the LCD 12A. A touch position on the screen which the pen 10A touches, a motion of the touch position, etc., are detected by the digitizer 12C.

The OS 201 is configured to issue an input event indicating that the finger has touched the screen and indicating the touch position in cooperation with a driver program controlling the touchpanel 12B. The OS 201 is also configured to issue an input event indicating that the pen 10A has touched the screen and indicating the touch position in cooperation with a driver program controlling the digitizer 12C.

The wireless communication device 107 is a device configured to perform wireless communication such as wireless LAN or 3G mobile communication.

The EC 108 is a single-chip microcomputer including an embedded controller for power management. The EC 108 includes a function of turning the tablet computer 10 on or off in accordance with a user's operation of a power button.

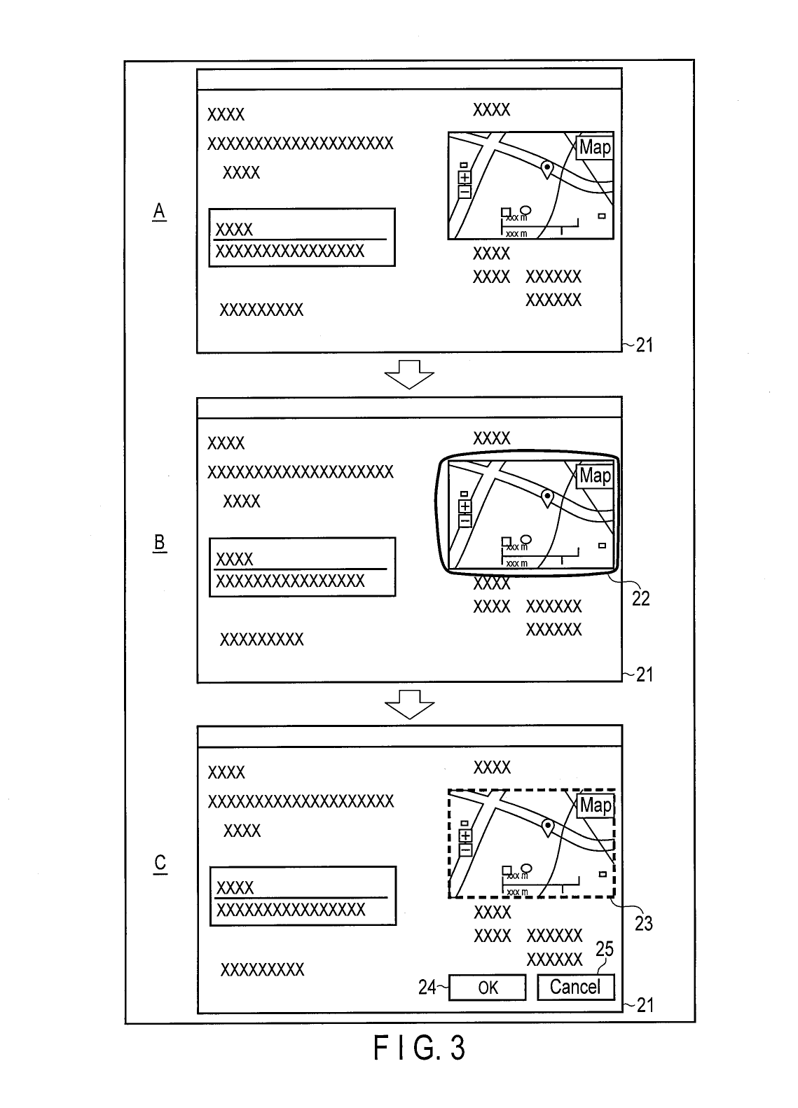

FIG. 3 shows an example of screen transition at the time of extracting a clip from a displayed document (Web page).

A document (Web page) 21 including texts and images is displayed on the screen. The user can, for example, display the desired Web page 21 on the screen by activating the browser application program 202 and executing so-called net surfing (“A” of FIG. 3).

The user often wants to save a portion in which the user is interested, a portion which the user wants to use later, and the like, in the Web page 21 while browsing the Web page 21. In such a case, the user performs a clipping operation of designating a clip range 22 in the displayed document by using various pointing devices such as the touchscreen display 12 (“B” of FIG. 3). The clipping operation is typically to enter a closed curve with the pen 10A. The entry of the closed curve does not need to be so precise as to cause a start point and an end point to correspond to each other. If it is estimated that the motion of the pen 10A is intended for the entry of the closed curve, the closed curve may be completed by adding a segment connecting the start point and the end point after the entry by the user.

The Web page 21 is displayed while texts, images, video, etc., are properly arranged based on a hypertext markup language (HTML) file acquired by a uniform resource locator (URL). Each of the texts, the images, the video and each aggregate of these are called an element. If the clipping operation of designating the clip range 22 is performed, the clipping module 203 incorporated in the browser application program 202 displays a frame 23 indicating an element which is to be a clipping target (“C” of FIG. 3). At this time, for example, an OK button 24 and a cancel button 25 are displayed. Thus, if a target element is the clipping target, the user can save the element as a clip by performing an operation of selecting the OK button 24.

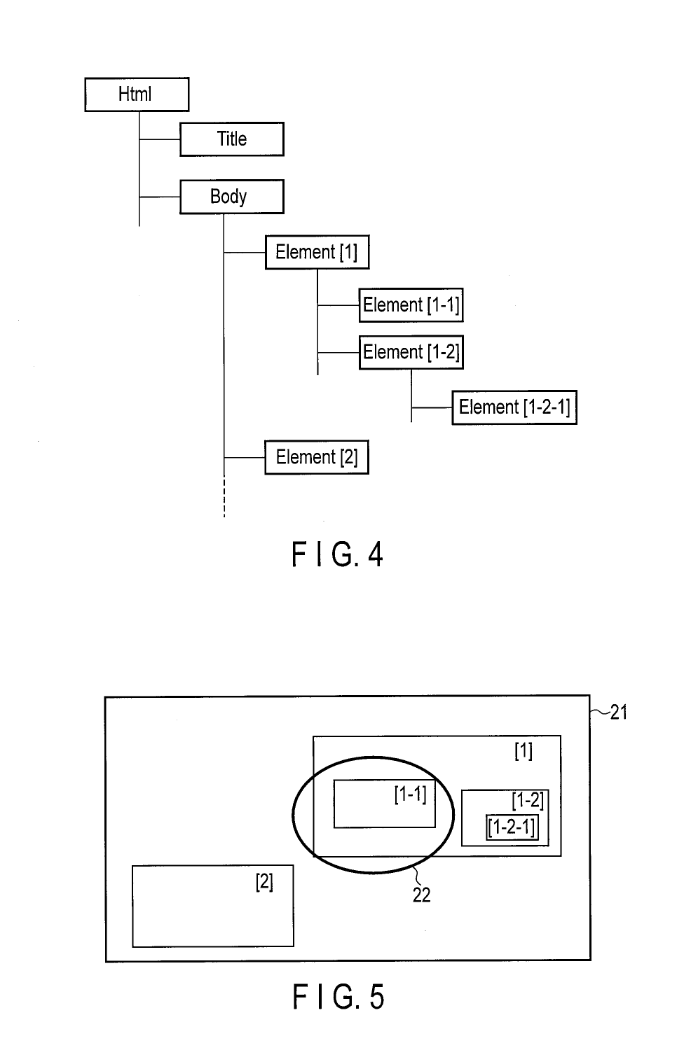

FIG. 4 is an exemplary illustration for explanation of a structure of the HTML file.

As shown in FIG. 4, the HTML file (corresponding to the single Web page 21) includes a title portion (“Title”) and a body portion (“Body”), and a plurality of elements (“Element [ ]”) are hierarchically described in the body portion. In an example of FIG. 4, an element [1] includes an element [1-1] and an element [1-2], and the element [1-2] includes an element [1-2-1]. A description of each element includes size and positional information.

FIG. 5 is an exemplary illustration showing an example of displaying the Web page 21 based on the HTML file shown in FIG. 4. As shown in FIG. 5, the element [1-1] and the element [1-2] are arranged in the element [1], and the element [1-2-1] is arranged in the element [1-2].

Here, it is assumed that the clip range 22 is designated as shown in FIG. 5. The clip range 22 is designated on the element [1]. However, the clip range 22 does not include the entire element [1], and thus the element [1] is excluded from the clipping target. On the other hand, the clip range 22 includes the entire element [1-1], and thus the element [1-1] is set as the clipping target. Which element is included in the clip range 22 can be determined by the aforementioned size and positional information included in the description of each element. Some margin is allowed for this determination. For example, if all of four reference points which are shifted from four corners of an element to a center of the element by a predetermined distance are included, the element may be set as the clipping target. Thus, it is possible to provide a user-friendly interface in which, for example, even if a closed curve which fails to include a corner of a target element is entered, the element is picked up as the clipping target.

Even if a region which the user wants to select can be designated by the operation using the pen 10A on the touchscreen display 12, similarly to the aforementioned designation of the clip range 22, designation of a region which the user wants to delete by the same operation using the pen 10A on the touchscreen display 12 as that at selection is difficult since the pen 10A (the digitizer 12C) basically has no modes. In the tablet computer 10, for example, both of a region which the user wants to select and a region which the user wants to delete can be designated by the operation using the pen 10A on the touchscreen display 12, and thereby an improvement in operability of region selection on the screen is achieved. This point will be hereinafter explained in detail.

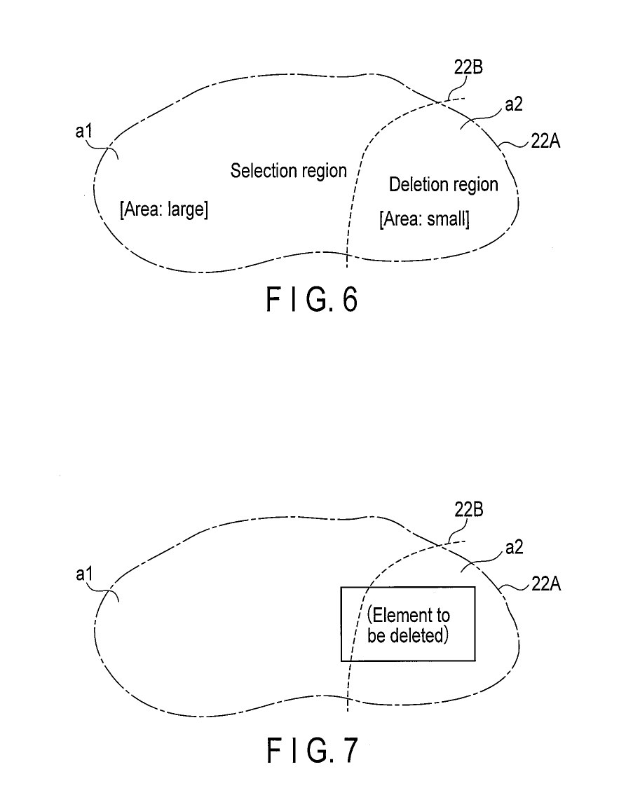

FIG. 6 is an exemplary illustration for explanation of a first pattern of a region deleting operation by a pointing device in the tablet computer 10.

First, it is assumed that, for example, a closed curve 22A is entered by the pen 10A on the touchscreen display 12 to designate the clip range 22 as shown in FIG. 6. Second, it is assumed that a segment 22B dividing the clip range 22 is entered by the pen 10A on the touchscreen display 12.

In this case, the clipping module 203 determines a region a1 having a larger area and a region a2 having a smaller area, of two regions in the clip range 22 divided by the segment 22B, as a selection region and a deletion region, respectively. Any existing methods for calculating an area are applicable, and the methods are not limited here. Thus, in the tablet computer 10, both of a region which the user wants to select and a region which the user wants to delete can be designated by the single pointing device. That is, an improvement in operability of region selection on the screen is achieved. The region which is designated as the clip range 22 by the closed curve 22A when the closed curve 22A is entered may also be an original selection region. That is, the selection region means a region selected as the clip range 22, not only a region selected from the two regions into which the clip range 22 is divided.

As a situation in which the user wants to delete a partial region in the clip range 22 after designating the clip range 22, a case in which the frame 23 shown in “C” of FIG. 3 is displayed for not only the target element but an unintended element is assumed. Thus, the clipping module 203 is required to exclude the unintended element from the clipping target in accordance with the designation of the deletion region. In this case, the clipping module 203 does not perform processing of searching for an element to be deleted from the deletion region (element included in the deletion region), but performs processing of searching for an element to be clipped from the selection region, which is a new clip range 22 (element included in the selection region). For example, if the segment 22B dividing the clip range 22 is not entered to allow the entire element to be deleted to be included in the deletion region as shown in FIG. 7, the element which the user wants to delete is not excluded from the clipping target even if the processing of searching for an element to be deleted from the deletion region is performed. On the other hand, if the processing of searching an element to be clipped from the selection region, which is the new clip range 22, is performed, the element which the user wants to delete can be surely excluded from the clipping target.

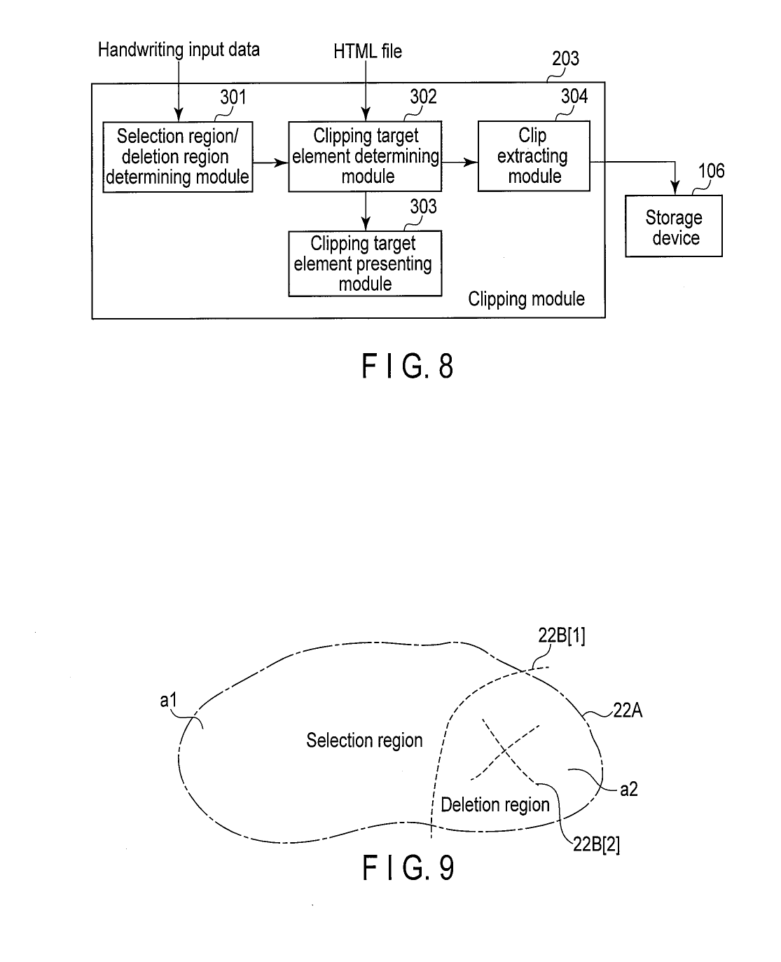

FIG. 8 is an exemplary functional block diagram of the clipping module 203 incorporated in the browser application program 202.

As shown in FIG. 8, the clipping module 203 includes a selection region/deletion region determining module 301, a clipping target element determining module 302, a clipping target element presenting module 303 and a clip extracting module 304.

The selection region/deletion region determining module 301 is a module configured to set the clip range 22 based on handwriting input data acquired by the touchpanel 12B or the digitizer 12C. More specifically, first, if it is estimated that the handwriting input data, which is continuously provided, is an entry of the closed curve 22A, the selection region/deletion region determining module 301 determines a region included in the closed curve 22A as the clip range 22, i.e., the selection region. Second, if it is estimated that the handwriting input data, which is continuously provided, is an entry of the closed curve 22B dividing the clip range 22, the selection region/deletion region determining module 301 determines a region having a larger area and a region having a smaller area of the two regions in the clip range 22 divided by the segment 22B as the selection region, i.e., the new clip range 22, and the deletion region, respectively.

The clipping target element determining module 302 is a module configured to receive a result of determination of the selection region (the clip range 22) by the selection region/deletion region determining module 301 and to determine an element to be the clipping target based on the HTML file of the displayed Web page 21. The clipping target element presenting module 303 is a module configured to present the user with the element which is set as the clipping target by the clipping target element determining module 302. The clip extracting module 304 is a module configured to save the element which is set as the clipping target by the clipping target element determining module 302 as a clip on, for example, the storage device 106.

By virtue of a function of the selection region/deletion region determining module 301, the user can perform both of designation of the selection region (entry of the closed curve 22A) and designation of the deletion region (entry of the segment 22B) by using, for example, the pen 10A.

Extracting an element from the displayed Web page 21 and saving the extracted element as a clip has been described. However, a technique for designating the deletion region by entering the segment 22B dividing the clip range 22 (set by entering the closed curve 22A) is not limited to this case, and can also be applied to various uses accompanied by region selection on the screen, for example, cutting out and saving a partial image from a displayed image.

Next, a second pattern of the region deleting operation by the pointing device in the tablet computer 10 will be described with reference to FIG. 9.

In the above-described first pattern, if the segment 22B dividing the clip range 22 (designated by entering the closed curve 22A on the touchscreen display 12 by using the pen 10A) is entered on the touchscreen display 12 by using the pen 10A, the selection region/deletion region determining module 301 of the clipping module 203 determines the region having a larger area and the region having a smaller area, of the two regions in the clip range 22 divided by the segment 22B, as the selection region and the deletion region, respectively.

On the other hand, in the second pattern, after a segment 22B[1] dividing the clip range 22 is entered, the selection region/deletion region determining module 301 of the clipping module 203 determines a region where a specific mark 22B[2] (here indicated by a cross) is entered, of the two regions in the clip range 22 divided by the segment 22B, as the deletion region.

In the second pattern, the user is supposed to carry out one additional operation (entry of the mark 22B[2]), but, for example, a region having an area of more than half of the clip range 22 designated by entering the closed curve 22A can be designated as the deletion region.

Then, a third pattern of the region deleting operation by the pointing device in the tablet computer 10 will be described.

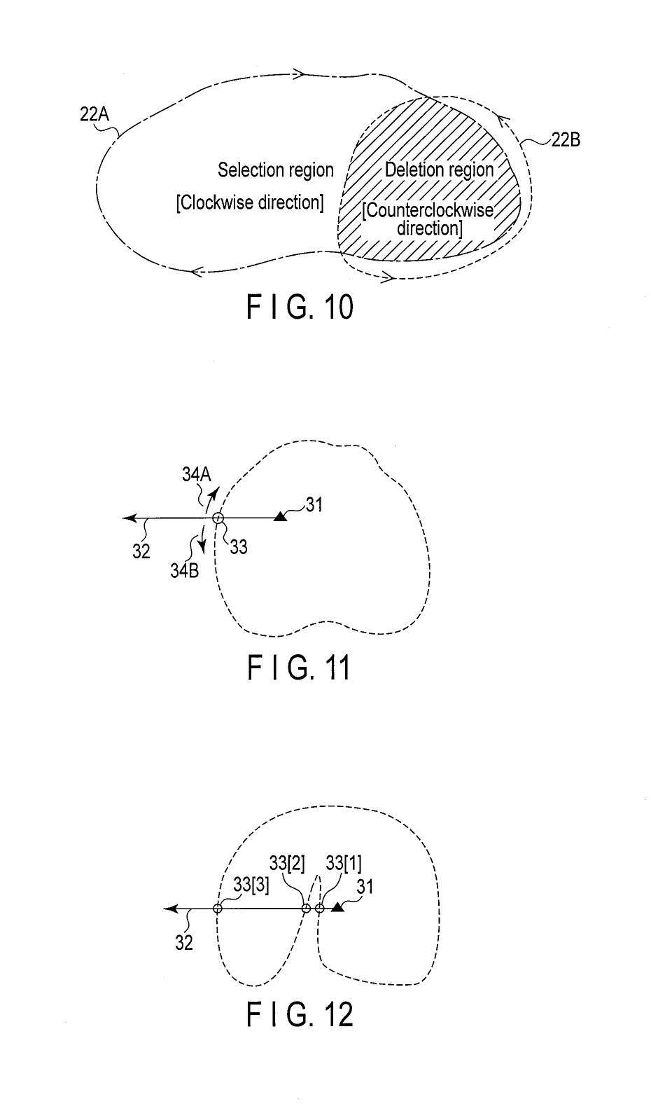

In the third pattern, if a closed curve is entered in, for example, a clockwise direction, the selection region/deletion region determining module 301 of the clipping module 203 determines that a region included in the closed curve is designated as the selection region. If a closed curve is entered in, for example, a counterclockwise direction (opposite to the clockwise direction), the selection region/deletion region determining module 301 determines that a region included by the closed curve is designated as the deletion region. FIG. 10 shows a state in which first the closed curve 22A is entered in the clockwise direction and then the closed curve 22B is entered in the counterclockwise direction.

When the closed curve 22A is entered in the clockwise direction, the selection region/deletion region determining module 301 determines the region included in the closed curve 22A as the clip range 22, i.e., the selection region. Then, when the closed curve 22B is entered in the counterclockwise direction, the selection region/deletion region determining module 301 determines the region included in the closed curve 22B in the clip range 22 as the deletion region. In other words, the selection region/deletion region determining module 301 determines a region other than the region included in the closed curve 22B in the clip range 22 as the selection region, i.e., the new clip range 22.

In the third pattern, for example, if the entire Web page 21 can be designated as the clipping target without entering the closed curve 22A, an unnecessary portion alone can be deleted by entering the closed curve 22B in the counterclockwise direction after the entire Web page 21 is designated as the clipping target.

Moreover, in the third pattern, for example, if the user wants to extend the clip range 22 after designating the clip range 22 by entering the closed curve in the clockwise direction, a region can be added to the clip range 22 by entering again the closed curve including the region which the user wants to add in the clockwise direction.

The selection region/deletion region determining module 301 determines whether the closed curve has been entered in the clockwise direction or in the counterclockwise direction, for example, in a manner shown in FIG. 11. The selection region/deletion region determining module 301 arbitrarily sets a reference point 31 inside the entered closed curve, virtually draws a segment 32 in a predetermined direction from the reference point 31, and determines whether an entry direction of the closed curve at an intersection 33 with the segment 32 is a direction 34A or a direction 34B. If the entry direction is the direction 34A, the selection region/deletion region determining module 301 determines that the closed curve has been entered in the clockwise direction. If the entry direction is the direction 34B, the selection region/deletion region determining module 301 determines that the closed curve has been entered in the counterclockwise direction.

Incidentally, the closed curve is not always entered in a circle and can also be entered in, for example, such a shape as shown in FIG. 12. More specifically, the segment 32 virtually drawn from the reference point 31 may intersect with the closed curve at a plurality of points. Even in such a case, the selection region/deletion region determining module 301 can correctly determine whether the closed curve is entered in the clockwise direction or in the counterclockwise direction by determining the entry direction of the closed curve at either of odd intersections 33[1, 3] from the reference point 31.

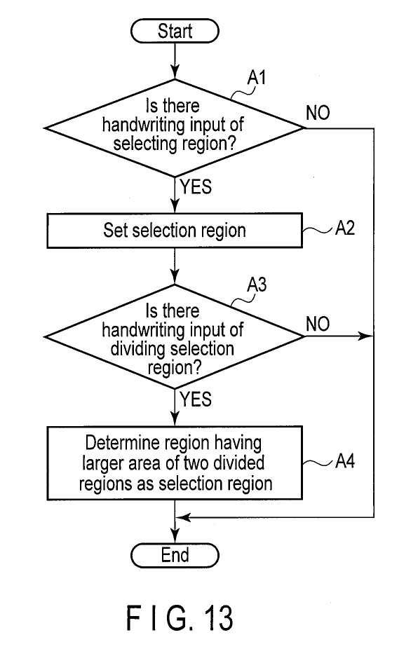

FIG. 13 is an exemplary flowchart showing a flow of region selection (first pattern) by the pen 10A in the tablet computer 10.

Upon recognizing handwriting input of selecting a region, for example, an entry of a closed curve (YES in block A1), the selection region/deletion region determining module 301 sets the region as the selection region (block A2). Upon recognizing handwriting input of dividing the set selection region, for example, an entry of a segment dividing the selection region into two regions (YES in block A3), the selection region/deletion region determining module 301 determines a region having a larger area of the two divided regions as a new selection region (block A4). In other words, a region having a smaller area is determined as the deletion region.

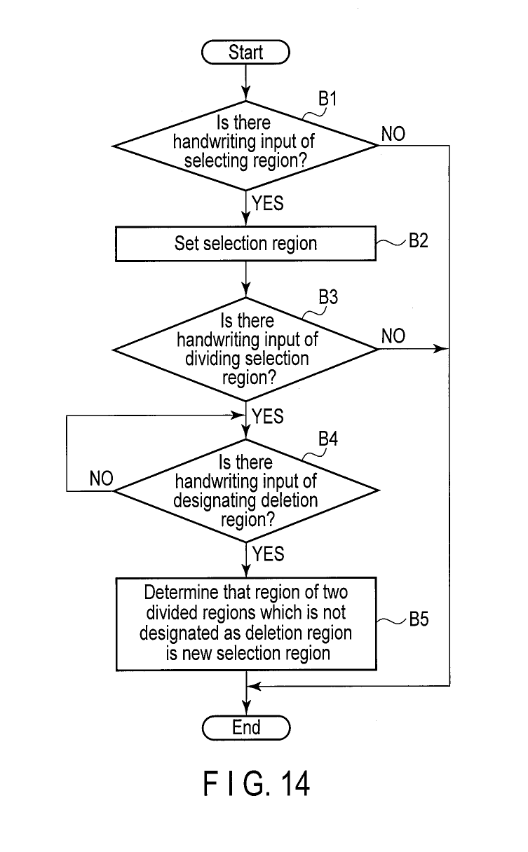

FIG. 14 is an exemplary flowchart showing a flow of region selection (second pattern) by the pen 10A in the tablet computer 10.

Upon recognizing handwriting input of selecting a region, for example, an entry of a closed curve (YES in block B1), the selection region/deletion region determining module 301 sets the region as the selection region (block B2). Upon recognizing handwriting input of dividing the set selection region, for example, an entry of a segment dividing the selection region into two regions (YES in block B3), the selection region/deletion region determining module 301 waits for handwriting input of designating one of the two divided regions as the deletion region, for example, an entry of a specific mark on either region (block B4).

Upon receiving handwriting input of designating the deletion region (YES in block B4), the selection region/deletion region determining module 301 determines that a region of the two divided regions which is not designated as the deletion region is a new selection region (block B5).

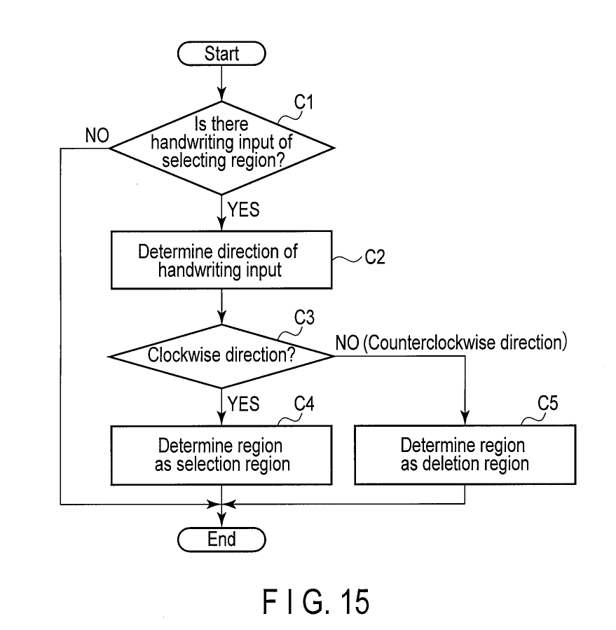

FIG. 15 is an exemplary flowchart showing a flow of region selection (third pattern) by the pen 10A in the tablet computer 10.

Upon recognizing handwriting input of selecting a region, for example, an entry of a closed curve (YES in block C1), the selection region/deletion region determining module 301 determines a direction of the handwriting input (block C2). If the direction is determined as the clockwise direction (YES in block C3), the selection region/deletion region determining module 301 determines the region as the selection region (block C4). On the other hand, for example, if the direction is determined as the counterclockwise direction (NO in block C3), the selection region/deletion region determining module 301 determines the region as the deletion region (block C5).

As described above, in the tablet computer 10, for example, both of the region which the user wants to select and the region the user wants to delete can be designated by the operation of the pen 10A on the touchscreen display 12. Thus, the improvement in operability of region selection on the screen is achieved.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising
a processor configured to designate, in accordance with a first operation for specifying a first region on first information displayed on a screen, the first region as a first selection region,
wherein the processor is configured to designate, in accordance with a second operation for specifying a second region in the first region, a region in the first region except the second region as a second selection region.

2. The apparatus of claim 1, wherein:
the second operation comprises an operation for entering a line dividing the first region; and
the second region comprises one of two regions in the first region divided by the line.

3. The apparatus of claim 1, wherein:
the second operation comprises an operation for entering a line dividing the first region and designating one of two regions in the first region; and
the second region comprises a region which is one of the two regions in the first region and which is designated in accordance with the operation for designating one of the two regions in the first region.

4. The apparatus of claim 1, wherein:
the first operation comprises an operation for entering a first closed curve in a first direction;
the second operation comprises an operation for entering a second closed curve in a second direction opposite to the first direction; and
the second region comprises a region included in the second closed curve in the first region.

5. The apparatus of claim 1, wherein:
the first information comprises a Web page described in hypertext markup language (HTML); and
the processor is configured to set an element in the first selection region or the second selection regions as a clipping target based on an HTML file of the Web page displayed on the screen.

6. The apparatus of claim 5, wherein the processor is configured to re-set an element in the second selection region as the clipping target if the second region is designated in the first region.

7. A method for an electronic apparatus, the method comprising:
designating with a processor, in accordance with a first operation for specifying a first region on first information displayed on a screen, the first region as a first selection region; and
designating with the processor, in accordance with a second operation for specifying a second region in the first region, a region in the first region except the second region as a second selection region.

8. The method of claim 7, wherein:
the second operation comprises an operation for entering a line dividing the first region; and
the second region comprises one of two regions in the first region divided by the line.

9. The method of claim 7, wherein:
the second operation comprises an operation for entering a line dividing the first region and designating one of two regions in the first region; and
the second region comprises a region which is one of the two regions in the first region and which is designated in accordance with the operation for designating one of the two regions in the first region.

10. The method of claim 7, wherein:
the first operation comprises an operation for entering a first closed curve in a first direction;
the second operation comprise an operation for entering a second closed curve in a second direction opposite to the first direction; and
the second region comprises a region included in the second closed curve in the first region.

11. The method of claim 7, wherein:
the first information comprises a Web page described in hypertext markup language (HTML), and
the method further comprises setting an element in the first selection region or the second selection regions as a clipping target based on an HTML file of the Web page displayed on the screen.

12. The method of claim 11, wherein the setting the element comprises re-setting an element in the second selection region as the clipping target if the second region is designated in the first region.

13. A computer-readable, non-transitory storage medium storing a computer program which is executable by a computer, the computer program controlling the computer to function as
a processor configured to designate, in accordance with a first operation for specifying a first region on first information displayed on a screen, the first region as a first selection region,
wherein the processor is configured to designate, in accordance with a second operation for specifying a second region in the first region, a region in the first region except the second region as a second selection region.

14. The medium of claim 13, wherein:
the second operation comprises an operation for entering a line dividing the first region; and
the second region comprises one of two regions in the first region divided by the line.

15. The medium of claim 13, wherein:
the second operation comprises an operation for entering a line dividing the first region and designating one of two regions in the first region; and
the second region comprises a region which is one of the two regions in the first region and which is designated in accordance with the operation for designating one of the two regions in the first region.

16. The medium of claim 13, wherein:
the first operation comprises an operation for entering a first closed curve in a first direction;
the second operation comprises an operation for entering a second closed curve in a second direction opposite to the first direction; and
the second region comprises a region included in the second closed curve in the first region.

17. The medium of claim 13, wherein:
the first information comprises a Web page described in hypertext markup language (HTML); and
the processor is configured to set an element in the first selection region or the second selection regions as a clipping target based on an HTML file of the Web page displayed on the screen.

18. The medium of claim 17, wherein the processor is configured to re-set an element in the second selection region as the clipping target if the second region is designated in the first region.
